(19) United States
(12) Patent Application Publication
(10) Pub. No.: US 2004/0035047 A1
(43) Pub. Date: Feb. 26, 2004

(54) Biotreatment of cheese-processing wastewater by cultivating mushroom mycelia

(75) Inventors: Seokhwan Hwang, Pohang-si (KR); Hwan-Young Lee, Nam-gu (KR)

Correspondence Address: Albert Wai-Kit Chan, Law Offices of Albert Wai-Kit Chan, LLC, World Plaza, Suite 604, 141-07 20th Avenue, Whitestone, NY, 11357, US

(73) Assignees: ENVITECH, INC.; POSTECH FOUNDATION

(21) Appl. No.: 10/643,537

(22) Filed: Aug. 18, 2003

(30) Foreign Application Priority Data
Aug. 20, 2002 (KR) 2002-49179

(51) Int. Cl. A01G 1/04

(52) U.S. Cl. 47/1.1

(57) ABSTRACT

Disclosed herein is a biological method for aerobically treating whey using mushroom mycelia wherein the whey can be biologically treated at a disposal rate comparable to conventional methods. According to the method, since environmentally unfriendly sludge is not discharged, post-treatment operations in connection with the disposal of sludge can be simplified. Therefore, the method can lower environmental costs and further enables the economical cultivation of mushroom mycelia. Furthermore, the method has an advantage in terms of resource recycling.

### BACKGROUND OF THE INVENTION

1. Field of the Invention

The present invention relates to a biological method for aerobically treating cheese-processing wastewater using mushroom mycelia wherein the cheese-processing wastewater can be biologically treated at a disposal rate (90% or higher) comparable to conventional methods, and at the same time, the mushroom mycelia can be economically cultivated in the cheese-processing wastewater without any sludge discharge, thereby eliminating the need for additional processing operations.

2. Description of the Related Art

Currently, a yearly average of at least 130,000,000 tons of cheese-processing wastewater (hereinafter, referred to as ‘whey’) are discharged throughout the world. As the number of cheese production facilities have been increasing by 3% a year for the past decade, discharge of whey is steadily on the rise.

Ingredients of whey are almost the same as those of milk, a raw material of cheese. Specifically, whey typically consists of 93% water, 4-5% (w/v) lactose, 0.8% (w/v) proteins, and 0.1-0.8% (w/v) lactic acid. Since whey is a highly concentrated organic substance which has a high chemical oxygen demand (COD) of 60,000-80,000 mg/L, it must be disposed of for environmental reasons. For example, 100 kg of whey is essentially equivalent to the amount of domestic sewage discharged per day by 45 adults in terms of pollution load. Only half of the whey discharged worldwide is treated to be reused in food supplements, animal feeds, fermentation media, etc. In the United States, the country responsible for 50% of the whey discharged worldwide, 3.4×10¹⁰ MT (metric tons) were discharged in 2000, which accounts for an increase of 19.2% over 1995. In Korea, 387,297 MT were discharged in 2000, which accounts for an increase of 246.6% over 1995.

Currently, whey, a highly concentrated organic wastewater, is biologically treated in accordance with environmental standards and then discharged into rivers and lakes. Conventional biological methods for aerobically treating whey are advantageous in removing organic materials included in the whey. However, this method is disadvantageous in that undesired by-products, e.g., sludge, are discharged in significant quantities, which increases environmental costs.

Mushrooms are microorganisms belonging to the basidiomycetes and ascomycetes based on the systematic botany classification. It is reported that about 15,000 mushroom species grow naturally worldwide, and about 230 species of edible or medicinal mushrooms grow in Korea. Examples of these mushrooms are Lentinus edodes, Pleurotus ostreatus, Flammulina velutipes, Ganoderma lucidum, Agaricus bisporus, Cordyceps militaris, Tricholoma matsutake, and Phellinus linteus, etc. In recent years, as many biotechnological advances have been rapidly made, special attention has been paid to various mushrooms as raw materials for functional foods, cosmetics, and pharmaceuticals.

Mushrooms are composed of mycelia (vegetative organ) and fruiting bodies (reproductive organ) which bear spores. As is well known in the art of mushroom growing, both the mycelia and the fruiting bodies of mushrooms exhibit pharmacological effects, such as anticancer, antiviral, antidiabetic, antithrombosis, etc. However, the mycelia contain components that are 50-60 times more effective in inducing these pharmacological effects than the fruiting bodies. In addition, to increase the efficacy, the mycelia can be mass-produced in all seasons and require less time and labor for conducting cultivation operations. Thus, the mycelia are more widely available as raw materials for functional foods, cosmetics and pharmaceuticals than the fruiting bodies.

Among the components included in mushrooms, one which exhibits immunostimulatory activity is a polysaccharide. It is well known that this mushroom polysaccharide is a single compound having a structure consisting of a β-1,3-glucan backbone and β-1,6 branches bonded thereto, and can exhibit a variety of effects useful for vital functions. In Japan, an extract from Lentinus edodes mycelia is generalized as a functional food. In addition, it was reported in 1992 that a polymeric polysaccharide extracted from the fruiting bodies of Agaricus blazei not only inhibits the growth of cancer cells, but is also effective against all immunity-related diseases, such as rheumatic arthritis, chronic bronchitis, and gastritis. Since then, great efforts have been undertaken to utilize the functions of Agaricus blazei. As a result, the extract has recently been commercialized as a functional food.

Mushrooms are also used as pharmaceuticals, e.g., anticancer (supplement) agents, based on their immunostimulatory effects. Polysaccharide-Krestin (PSK) a protein-bound polysaccharide extracted from the cultured mycelia of Coriolus versicolor, is commercially available as a powder of Krestin, an immnostimulatory agent for anticancer therapy. Shizophyllan, an extracellular polysaccharide extracted from the cultured mycelia of Schizophyllum commune is also commercially available as an injectable preparation of lentinan, an immunostimulatory agent for anticancer therapy. These polysaccharides are intracellular components of the mycelia, and the amount of these polysaccharides in the mycelia increases in proportion to the growth of the mass of the mycelia.

In summary, extracts of mushroom mycelia are proven to have antitumor properties, immunomodulating effects, and stability through clinical trials. Thus, industrial studies on a variety of mushroom species are being actively undertaken.

### SUMMARY OF THE INVENTION

In order to solve the aforementioned problems of conventional methods for whey treatment, the present inventors have conducted intensive research in order to develop methods for treating whey using mushroom mycelia which can be reused as food and animal feed supplements and which may also be used for their pharmacological effects such as anticancer, immunostimulation, etc. Therefore, it is an objective of the present invention to provide a biological method for treating whey using mushroom mycelia wherein the whey can be biologically treated at a disposal rate comparable to conventional methods, while at the same time, the mushroom mycelia can be mass-produced in the whey without any discharge of environmentally unfriendly sludge, thereby lowering environmental costs, which is advantageous in terms of resource recycling.

In order to accomplish the above objective of the present invention, there is provided a method for treating whey, comprising the steps of:

separating proteins from a whey stock solution;

placing the protein-free solution as a medium in a reactor at 25˜32° C. and pH 3.8˜4.6; and

aerobically culturing mushroom mycelia in the reactor.

Preferably, the pH and temperature of the reactor are 4.2 and 28.3° C., respectively. The mushroom is preferably at least one species selected from the group consisting of Ganoderma lucidum, Lentinus edodes, Pleurotus ostreatus, Phellinus linteus and Agaricus bisporus.

The present invention also accomplishes a method for cultivating mushroom mycelia in whey wherein the whey can be biologically treated at a disposal rate of 90% or higher, while at the same time, the mushroom mycelia can be cultivated without any discharge of environmentally unfriendly sludge.

In order to effectively treat the whey and maximize resource recycling, the five mushroom mycelia were screened to select mycelia having excellent adaptability. First, a multiple regression analysis for optimizing operational conditions of respective processes was performed using the selected mycelia. Then, model equations were built, and an equal altitude analysis and a three-dimensional analysis were performed using a response surface method to examine the significance of the results. As a result, optimum conditions for removing organic substances and cultivating the mushroom mycelia were obtained.

Since the method of the present invention enables the cultivation of mushroom mycelia which exhibits anticancer and immunostimulatory effects without any discharge of environmentally unfriendly sludge, it contributes to the reduction of environmental costs. That is, the method of the present invention can effectively treat whey and is advantageous in terms of resource recycling.

According to the method of the present invention, cultivation of mushroom mycelia is environmentally friendly, economically advantageous, and further expected to be utilized in various applications. For example, since the reduced sludge discharge leads to downsizing of sludge treatment facilities, the method of the present invention contributes to reduction of sludge treatment costs. In addition, when mushroom mycelia are cultivated in accordance with the method of the present invention, new economical profits can be created.

Furthermore, the mushroom mycelia cultivated in accordance with the method of the present invention can exhibit considerable efficacy against various cancers, hepatitis, hypertension, arthritis, bronchitis, etc.

### BRIEF DESCRIPTION OF THE DRAWINGS

The above, and other objectives, features, and advantages of the present invention will be more clearly understood from the following detailed description taken in conjunction with the accompanying drawings:

FIG. 1 is a graph showing the mycelial growth rate of Ganoderma lucidum with increasing concentrations of whey;

FIG. 2 is a graph showing the mycelial growth rate of Lentinus edodes with increasing concentrations of whey;

FIG. 3 is a graph showing the mycelial growth rate of Pleurotus ostreatus with increasing concentrations of whey;

FIG. 4 is a graph showing the mycelial growth rate of Phellinus linteus with increasing concentrations of whey;

FIG. 5 is a graph showing the mycelial growth rate of Agaricus bisporus with increasing concentrations of whey;

FIG. 6 shows optimum conditions for the cultivation of mushroom mycelia using a response surface method; and

FIG. 7 shows optimum conditions for treating organic substances in whey using a response surface method.

### DESCRIPTION OF THE PREFERRED EMBODIMENTS

The present invention will now be described in more detail with reference to the following examples. However, these examples are given for the purpose of illustration and are not to be construed as limiting the scope of the invention.

### EXAMPLE

Step 1: Species and their Storage

Mushroom mycelia used in this example were purchased from the Korean Collection for Type Cultures (KCTC, gene bank) and the American Type Culture Collection (ATCC). The respective mushroom mycelia were stored in slant potato dextrose agar (PDA) media where they were subcultured every 3 months. The depository authorities of the species and their accession numbers are listed in Table 1 below.

TABLE 1

| Species | Accession Nos. |
|---|---|
| Ganoderma ludium | KCTC 6283 |
| Lentinus edodes | KCTC 6735 |
| Pleurotus ostreatus | KCTC 16812 |
| Phellinus linteus | KCTC 6719 |
| Agaricus bisporus | ATCC 9672 |

Step 2: Pretreatment of Whey

1N HCl was added to a whey stock solution to adjust the is pH of the mixture to 4.6, which is the isoelectric point of casein. At this point, proteins were precipitated. The resulting mixture was centrifuged (8,000 rpm, 15 minutes) to separate the precipitated proteins. The obtained supernatant was stored in a storage tank where the supernatant was pasteurized for the cultivation of mushroom mycelia. The separated proteins were spray-dried to prepare a final product for sale.

Step 3: Screening of Mushroom Mycelia Having Excellent Adaptability

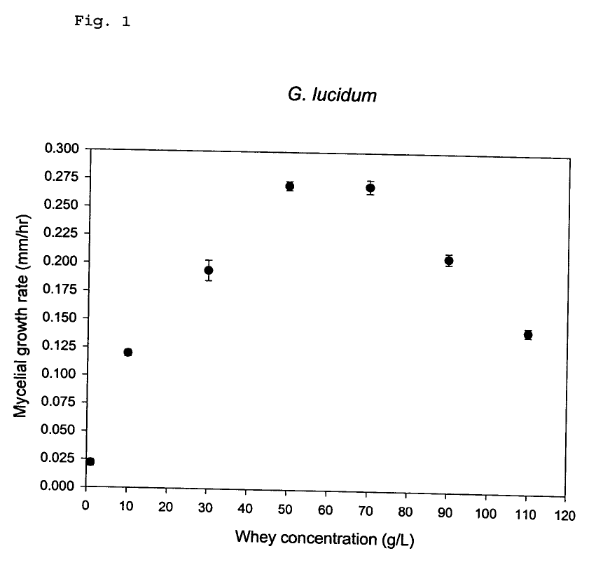

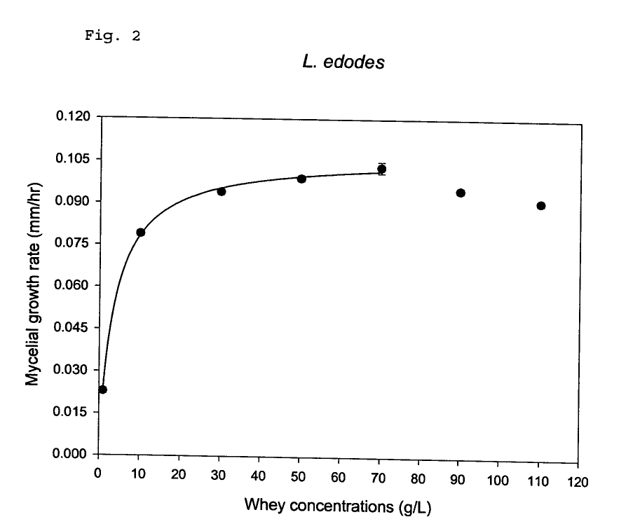

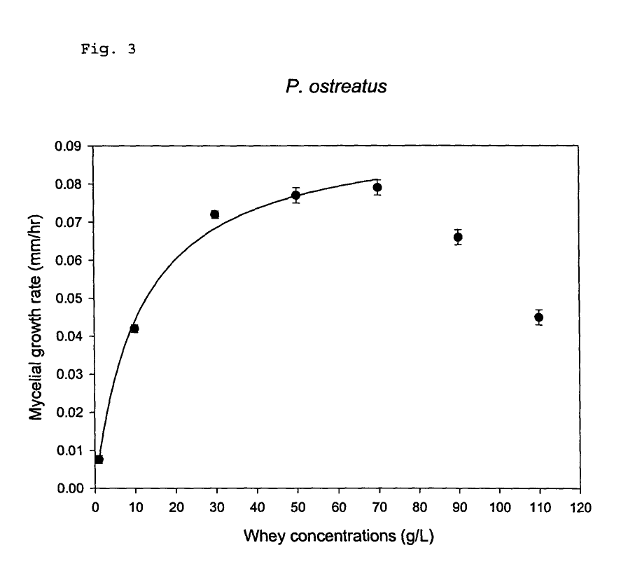

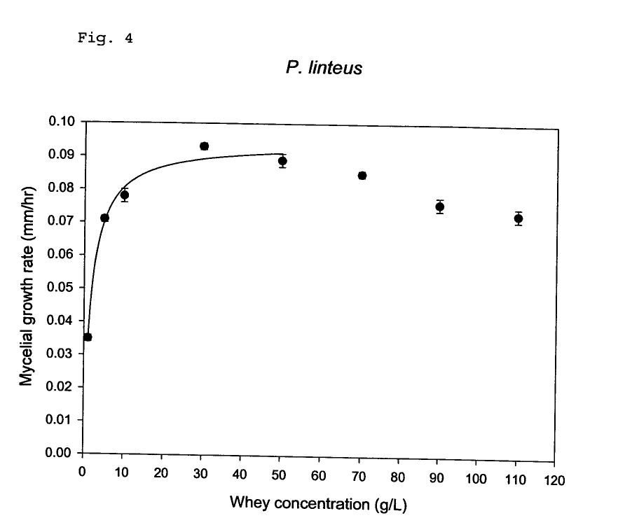

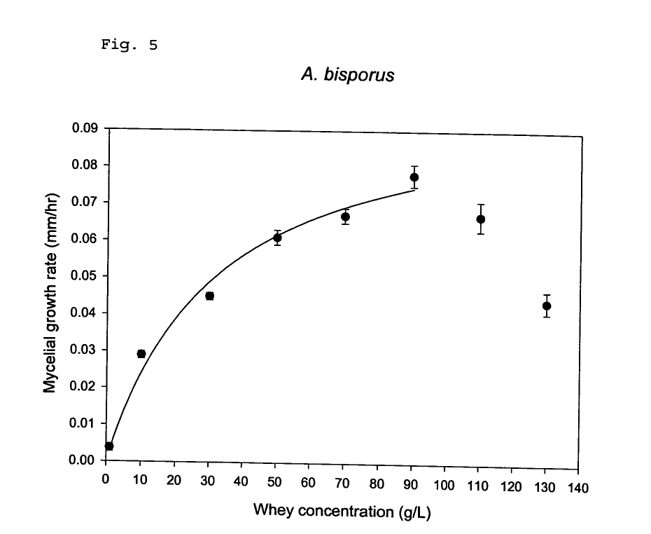

In this step, optimum concentrations for the growth of mushroom mycelia were examined at various diluted concentrations of a whey stock solution. The mycelial growth rates of mushrooms were compared with those in traditional media through observation of the hyphal extension rates of the mushrooms. FIGS. 1 through 5 show the mycelial growth rates of Ganoderma lucidum, Lentinus edodes, Pleurotus ostreatus, Phellinus linteus and Agaricus bisporus with increasing concentrations of whey, respectively. As shown in FIGS. 1 through 5, Ganoderma lucidum mycelia exhibited the highest adaptability. The hyphal extension rates of each mushroom mycelium in traditional media are shown in Table 2 below.

| | G. | L. | P. | P. | A. |
|---|---|---|---|---|---|
| | ludium | edodes | ostreatus | linteus | bisporus |
| Glucose peptone | 0.363 | 0.121 | 0.156 | 0.070 | 0.127 |
| yeast (GPY) | (0.006) | (0.004) | (0.004) | (0.001) | (0.007) |
| Yeast agar (YA) | 0.302 | 0.160 | 0.164 | 0.082 | 0.137 |
| | (0.006) | (0.004) | (0.004) | (0.001) | (0.010) |
| [symbol] | 0.180 | 0.129 | 0.077 | 0.088 | 0.066 |
| | (0.010) | (0.003) | (0.003) | (0.001) | (0.004) |
| Glucose [symbol] | 0.160 | 0.123 | 0.066 | 0.048 | 0.032 |
| [symbol] | (0.005) | (0.003) | (0.002) | (0.001) | (0.001) |
| [symbol] | 0.352 | 0.083 | 0.110 | 0.077 | 0.072 |
| | (0.005) | (0.006) | (0.003) | (0.001) | (0.005) |
| Potato dextrose agar | 0.366 | 0.188 | 0.166 | 0.085 | 0.210 |
| (PDA) | (0.005) | (0.003) | (0.003) | (0.001) | (0.009) |

Step 4: Culture of Inoculum

Five mycelial discs (diameter: 5 mm) were cut from an active growth zone on an agar plate, which had been previously cultured in PDA for 4 days, then inoculated to an Erlenmeyer flask containing a liquid medium of potato dextrose broth (PDB). The inoculated medium was subjected to a shaking culture method with stirring at 120 rpm for 8 days in order to obtain an inoculum in the exponential phase, which exhibits good microbial activity.

Step 5: Optimization for Maximization of Whey Treatment and Mycelial Cultivation

(1) Addition of Inoculum

The object of this step is to optimize mycelial cultivation through the inoculation of whey using an enriched inoculum. A starting inoculum was obtained by seeding the inoculum in a 250 ml Erlenmeyer flask containing 100 ml PDB, and culturing it in a shaking incubator at 120 rpm for 8 days. After a primary seed culture time of 8 days, mycelia (dry weight: 1,757±132 mg/L) were homogenized for 10 seconds, and then inoculated to a 7 L bioreactor containing 4 L of whey.

(2) Operation of Reactor

In this step, a 7 L fermentor (model Bio-G, made by Biotron Inc., Korea) equipped with a thermostat, an agitation speed controller, a dissolved oxygen sensor, and a pH sensor, each of which was automatically controlled, was used as a reactor. Oxygen was fed to the fermentor using an air compressor through a filter. The flow rate of oxygen was set to 1 vol/vol/min.

(3) Sampling and Analysis

The Concentration of mycelia was obtained by centrifuging a collected sample at 6,000 rpm for 30 minutes to separate the mycelia from the collected sample, and then measuring the dry weight of the separated mycelia.

The concentration of lactose remaining in the cultured solution was analyzed by centrifuging samples collected at predetermined time intervals and analyzing the resulting supernatants by a refractive index detector of high performance liquid chromatography (HPLC). At this time, a mixture of acetonitrile and water (H₂O) (83:17) was used as a mobile phase, and Supelcosil LC-NH₂ chromatographic column (5 μm, 250 mm×4.6 mm i.d) was used as a column. The flow rate of the mobile phase was set to 1.5 mL/min. The overall procedure was carried out at room temperature.

The concentration of organic substances contained in the whey was determined using COD chromium absorptiometry in accordance with a standard method (American Public Health Association). The concentration of ions contained in the whey was determined using ion chromatography. In addition, the total phosphorus and total nitrogen were determined using the ascorbic acid reduction method and the reduction/distillation-Kjeldahl method, respectively, in accordance with the test methods for water quality management.

The concentrations of ingredients contained in the whey were analyzed prior to performing the method of the present invention. The results are shown in Table 3 below.

TABLE 3

| | | | Concentrations |
|---|---|---|---|
| Components | Concentrations (mg/L) | Components | (mg/L) |
| Total COD | 56,167 ± 298 | Na⁺ | 327 ± 4 |
| Soluble COD | 52,993 ± 534 | NH₄⁺ | 250 ± 4 |
| Carbohydrates | 43,955 ± 206 | K⁺ | 1,118 ± 10 |
| Lactose | 40,000 ± 340 | Ca²⁺ | 275 ± 2 |
| Total Organic | 16,712 ± 664 | Mg²⁺ | 60 ± 0.6 |
| Carbon | | | |
| Total nitrogen | 595 ± 18 | Cl⁻ | 1,300 ± 42 |
| Total phosphorus | 740 ± 20 | NO₂²⁻ | 9 ± 2 |
| Acetic acid | 427 ± 90 | NO₃²⁻ | 30 ± 5 |
| Butyric acid | 18 ± 0.3 | PO₄²⁻ | 638 ± 5 |
| | | SO₄²⁻ | 62 ± 1 |

(4) Optimization

The object of this step is to optimize the cultivation of Ganoderma lucidum mycelia and the whey treatment.

The optimum temperature and pH, which strongly affect the growth of Ganoderma lucidum mycelia, were examined by performing a central composite design (CCD) with analysis using a second-order model (see, equations 1 and 2 below). The optimum temperature and pH for mycelial cultivation were determined to be 28.3° C. and 4.2, respectively. At the optimum points, it was shown that the mycelial dry weight was 21 g/L, and the disposal rate of organic substances was 93%.

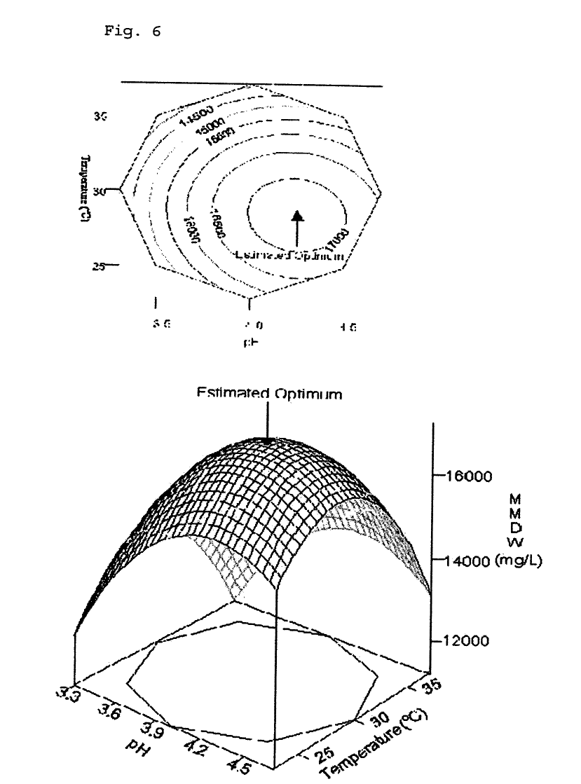

FIG. 6 shows optimum conditions for the cultivation of Ganoderma lucidum mycelia using a response surface method. As can be seen from FIG. 6, the concentration of Ganoderma lucidum mycelia at 25-32° C. and pH 3.8-4.6 was 18 g/L or more. The concentration exhibited 1.07 times higher than that (16.81 g/L) reported in a Korean dissertation.

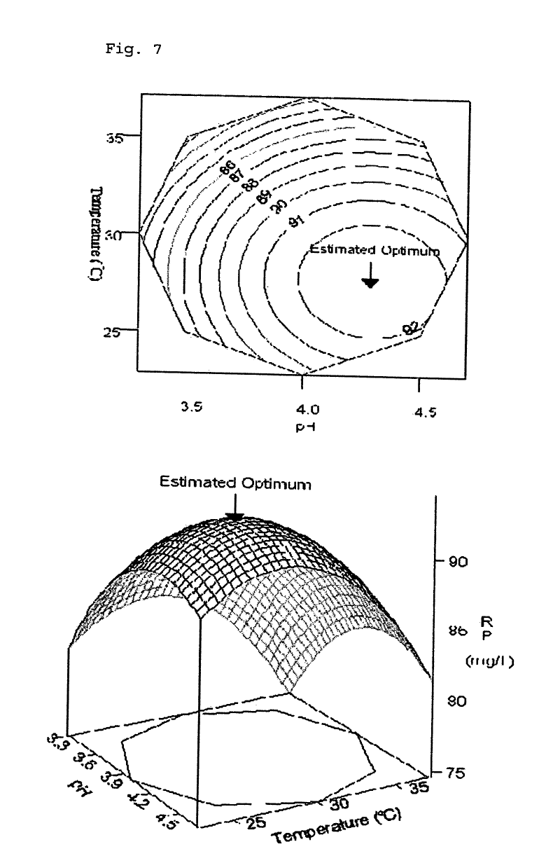

FIG. 7 shows optimum conditions for treating organic substances in whey using a response surface method. As can be seen from FIG. 7, the disposal rate of whey was maximal at 25-32° C. and pH 3.8-4.6.

Y_{MMDW2}=−88,999+31,996x₁+2,689x₂−49x₁x₂−3,600x₁²+44x₂² (Equation 1)

Y_{RP2}=−165.5+79.6x₁6.3x₂−0.04x₁x₂−9.1x₁²−0.1x₂² (Equation 2)

The experimental conditions and results of the central composite design are shown in Table 4 below.

TABLE 4

| | Actual variables | | Coded variables | | | |
|---|---|---|---|---|---|---|
| | | Tempera- | | Tempera- | Response | |
| Trials | pH | ture (° C.) | pH | ture (° C.) | MMDW^{b} (mg/L) | RP^{c} (%) |
| 1 | 3.5 | 25 | −1 | −1 | 14,269 | 87.26 |
| 2 | 4.5 | 25 | +1 | −l | 16,520 | 92.36 |
| 3 | 3.5 | 35 | −1 | +1 | 13,365 | 80.65 |
| 4 | 4.5 | 35 | +1 | +1 | 15,123 | 85.36 |
| 5^{a} | 4.0 | 30 | 0 | 0 | 16,945 | 91.60 |
| | | | | | (475) | (1.48) |
| 6 | 4.0 | 37.1 | 0 | [symbol] | 13,985 | 84.05 |
| 7 | 4.0 | 22.9 | 0 | [symbol] | 15,789 | 88.25 |
| 8 | 4.7 | 30.0 | [symbol] | 0 | 16,324 | 91.26 |
| 9 | 3.3 | 30.0 | 0 | [symbol] | 14,320 | 83.26 |

^{a}An average of values obtained through 5 repeated experiments (Standard deviation)
^{b}MMDW: Maximum Mycelial Dry Weight
^{c}RP: Removal Percentage of whey COD

^{a}An average of values obtained through 5 repeated experiments (Standard deviation)

^{b}MMDW: Maximum Mycelial Dry Weight

^{c}RP: Removal Percentage of whey COD

### Experimental Example

Analysis of ingredients contained in extract from Ganoderma lucidum mycelia

After water was added to Ganoderma lucidum mycelia in an equal volume of Ganoderma lucidum mycelia and left at 100° C. for 3 hours, the mixture was centrifuged. The resulting supernatant was collected and ethanol was added thereto. At this time, the volume of ethanol used was 4 times greater than that of the supernatant. The ethanolic mixture was stored in a freezer at 4° C. for 24 hours to precipitate the physiologically active components of the mycelia. The precipitates were dried at 55° C. to obtain an extract from Ganoderma lucidum mycelia (1,820 mg/L). Components (saccharides, proteins, minerals, etc.) of the extract were analyzed. The results are shown in Table 5 below.

TABLE 5

| | | | Ratio |
|---|---|---|---|
| Components | Concentrations (mg/l) | Standard deviation | (%) |
| Polysaccharides | 1,120 | 13 | 62 |
| Proteins | 32 | 3 | 2 |
| Cu | 0.15 | 0.03 | 0.01 |
| Fe | 0.77 | 0.14 | 0.04 |
| K | 24.93 | 3.79 | 1.37 |
| Mg | 11.19 | 0.21 | 0.61 |
| Na | 10.46 | 1.03 | 0.57 |
| Zn | 0.86 | 0.05 | 0.05 |
| Al | 0.52 | 0.10 | 0.03 |
| P | 40.22 | 1.04 | 2.21 |
| Ca | 1.82 | 0.11 | 0.10 |

After biologically treating the whey at the optimum conditions in accordance with the method of the present invention, the concentrations of remaining lactose, organic substances, total phosphorus and total nitrogen were measured, then the disposal rates of the respective components were calculated.

TABLE 6

| | Before treatment | After treatment | Disposal rates |
|---|---|---|---|
| Components | (mg/l) | (mg/l) | (%) |
| Soluble COD | 52,993 | 3,000 | 93 |
| Lactose | 40,000 | 1,000 | 97 |
| Total phosphorus | 595 | 200 | 66 |
| Total nitrogen | 740 | 350 | 53 |

As can be seen from Table 6, according to the biological method for treating whey using mushroom mycelia of the present invention, the whey can be biologically treated with high efficiency without any sludge discharge, thereby eliminating the need for additional processing operations (anaerobic or aerobic process). In addition, the final form of treated whey (that is, mycelial culture) can be spray-dried to prepare food and animal feed supplements for retail sale. Furthermore, extremely careful management of the method can eliminate intermediate processing operations.

As described previously, according to the method of the present invention, mushroom mycelia can be mass-produced in whey without any discharge of environmentally unfriendly sludge, a problem of conventional biological methods for aerobically treated whey. In addition, the produced mushroom mycelia can be reused as food and animal feed supplements or as nutritional supplements due to the pharmacological effects they exhibit, such as anticancer, immunostimulation, etc.

In other words, according to the method of the present invention, since whey can be biologically treated at a disposal rate comparable to conventional biological methods for aerobically treated whey without discharging environmentally unfriendly sludge, post-treatment operations in connection with the disposal of sludge can be simplified. Accordingly, the present invention can lower environmental costs and further enables the economical cultivation of mushroom mycelia.

Furthermore, since the method of the present invention can accomplish the optimization of operational conditions using a response surface method for a statistical experimental design, mushroom mycelia can be mass-produced in a shortened culture period. In particular, since the present invention enables the mass-production of a protein-bound polysaccharide as an anticancer agent using Ganoderma lucidum mycelia at reduced cost, it is very useful in the biological and medical industries.

Although the preferred embodiments of the present invention have been disclosed for illustrative purposes, those skilled in the art will appreciate that various modifications, additions, and substitutions are possible without departing from the scope and spirit of the invention as disclosed in the accompanying claims.

What is claimed:

1. A method for treating whey, comprising the steps of:
separating proteins from a whey stock solution;
placing the protein-free solution as a medium in a reactor at 25˜32° C. and pH 3.8˜4.6; and
aerobically culturing mushroom mycelia in the reactor.

2. The method for treating whey according to claim 1, wherein the reactor is maintained at 28.3° C and pH 4.2.

3. The method for treating whey according to claim 1, wherein the mushroom is at least one species selected from the group consisting of Ganoderma lucidum, Lentinus edodes, Pleurotus ostreatus, Phellinus linteus and Agaricus bisporus.

4. A method for culturing and cultivating mushroom mycelia, comprising the steps of:
separating proteins from a whey stock solution;
placing the protein-free solution as a medium in a reactor at 25˜32° C. and pH 3.8˜4.6; and
aerobically culturing mushroom mycelia in the reactor.

5. The method for culturing and cultivating mushroom mycelia according to claim 4, wherein the reactor is maintained at 28.3° C. and pH 4.2.

6. The method for culturing and cultivating mushroom mycelia according to claim 4, wherein the mushroom is at least one species selected from the group consisting of Ganoderma lucidum, Lentinus edodes, Pleurotus ostreatus, Phellinus linteus and Agaricus bisporus.
